(19) United States
(12) Patent Application Publication
(10) Pub. No.: US 2003/0048391 A1
(43) Pub. Date: Mar. 13, 2003

(54) Projection television having an improved mirror system

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(21) Appl. No.: 09/947,412

(22) Filed: Sep. 7, 2001

(51) Int. Cl. H04N 5/74

(52) U.S. Cl. 348/782

(57) ABSTRACT

A projection television system includes an image source or projector, a projection screen, and at least one mirror positioned so as to reflect an image from the projector to the projection screen, and also to expand the image in at least one of respective first and second mutually transverse planes. The at least one image expanding mirror may be part of a mirror system consisting of simple partially cylindrical mirrors that separately expand the image in the vertical and horizontal planes, or may take the form of a single spherical mirror similar to a wide angle fisheye or truck mirror having image expansion properties in both planes. Alternatively, one or more image expanding mirror may be in the form of, or include, reflective sheets that include image-expanding lenticular surfaces.

### BACKGROUND OF THE INVENTION

1. Field of the Invention

This invention relates to rear projection televisions, and in particular to a rear projection television having an improved mirror system.

The improved mirror system includes curved surfaces that magnify the projected image so as to reduce the path length required by the projected image for a given screen size, and thereby reduce the overall size of the television.

2. Description of Related Art

The goal of all rear projection television designs is to enable television images to be displayed on screens that are significantly larger than is achievable or practical with conventional CRT or LCD technology, by projecting the image from a relatively small image source within the television onto the rear of the screen. The larger display size enhances the viewing experience, bringing theater quality effects to relatively small venues such as living rooms and taverns, without the inconvenience and space required by a front projection system.

While early projection televisions suffered from poor image quality, excessive bulk, and extremely high cost in relation to conventional televisions, recent improvements in screens and projection optics have substantially reduced the size and cost of rear projection televisions, and greatly improved the image quality, leading to vastly increased consumer acceptance. Nevertheless, the size and cost of current projection televisions still prevents many potential users from benefitting from the increased screen size.

In any kind of projection system, the greater the effective distance between the projector and the screen onto which the image is projected, the larger the projected image. If the image is projected onto the front of the screen, then the image size can be increased simply by moving the projector away from the screen. In a rear projection system, the same effect is achieved by using mirrors to lengthen the path taken by the image from the projector to the screen.

Since geometry imposes a limit on the number of times the image can be bent or folded, further reductions in the size of a rear projection television can only be achieved by optically enlarging the image as it is projected onto the screen, or by projecting the image at a relatively acute angle and accepting some distortion. By way of example, a basic rear projection screen arrangement is illustrated in U.S. Pat. No. 4,147,408, while modifications of the projection system for the purpose of reducing the size of the system without reducing the optical path length, and therefore the size of the projected image, are disclosed in U.S. Pat. Nos. 4,512,631; 4,578,710; 4,708,435; 4,963,016; 5,208,620; and 5,803,567.

Each of these conventional projection televisions uses image enlarging lenses or prisms, in combination with specially designed collimating screens, to significantly reduce the thickness of the televisions. In practice, such rear projection televisions have been reduced in thickness to the point where they are no thicker than a conventional non-projection television offering a much smaller screen. Nevertheless, a rear projection television that is no thicker or deeper than a conventional television will still be considerably bulkier. In addition, the lenses used to reduce the size of the television add to the cost, and the reduction in size achievable through the use of lenses or prisms is limited by the inherent aspheric distortion introduced by the lens, which must be compensated for by additional lenses, all of which take up space and add to the cost of the system.

Furthermore, no matter how the relationship between projector, mirror, and screen is adjusted, a limitation on size reduction is provided by the mirrors themselves, which are still essential to increase the optical path length by folding the optical path. In general, the closer the mirror is to the screen, the larger the mirror required, offsetting any gains from re-positioning of the mirror. For conventional mirrors, the laws of physics essentially dictate a minimum mirror size and maximum angle between the mirror and the screen.

The present invention approaches the problem of rear projection television size-reduction by using reflective image expansion rather than lenses or prisms to shorten the path length. In preferred embodiments, the invention uses one mirror to expand the image in the horizontal direction and another to expand the image in the vertical direction, although it is also within the scope of the invention to combine the functions of the two mirrors into a single mirror, or to combine a conventional mirror with a single mirror that expands the image in either the horizontal or vertical direction. The mirrors used may be simple partially cylindrical mirrors, conventional wide-angle “fish eye” mirrors similar to those used on large trucks, or reflective sheets having image expanding properties as disclosed in copending U.S. patent application Ser. No. 09/934,641, filed Aug. 23, 2001, entitled “Reflective Sheets And Applications Therefor.” and herein incorporated by reference.

The mirror system of the invention may be used by itself or with additional lenses to focus, collimate, and/or further enlarge the image, compensate for distortion, or for any other purpose for which lenses are conventionally used in projection televisions, so long as the system uses at least one mirror to expand the image in mutually transverse directions.

It is noted that the abstract of one of the above-cited references, U.S. Pat. No. 4,578,710 (Hasegawa), mentions the use of a “plano-concave mirror” and a “plano-convex mirror.” So far as it is possible to determine, the use of the adjectives “plano-concave” and “plano-convex” before “mirror” in the abstract of this patent appears to result from a typographic error since the drawings, specification, and claims of the patent refer only to plano-concave and plano-convex lenses. Furthermore, even if the description in the abstract of this patent were accurate, the description does not refer to the use of a wide angle spherical mirror, or two cylindrically curved mirrors arranged such that the first mirror expands the image in a first plane and the second mirror expands the image in a second plane transverse to the first plane.

### SUMMARY OF THE INVENTION

It is accordingly a first objective of the invention to provide a projection television having a reduced size.

It is a second objective of the invention to provide a projection television that is relatively simple to manufacture and has a reduced cost.

It is a third objective of the invention to provide a projection television in which size is reduced by means of conventional, relatively inexpensive mirrors, without the need for more complex image-enlarging optical systems.

It is a fourth objective of the invention to provide reflectors and reflector systems that permit a significant reduction in the size, and in particular the depth, of a rear projection television, and yet that are made up of readily available, relatively low cost, mirror structures.

These objectives are achieved, in accordance with the principles of a first preferred embodiment of the invention, by providing a projection television system that includes, as is conventional, an image source or projector, a projection screen, and at least one mirror positioned so as to reflect an image from the projector to the projection screen. Instead of using conventional a planar or substantially planar reflector, however, the at least one mirror is arranged to expand the image in respective first and second mutually transverse planes.

The at least one image expanding mirror may, according to a first preferred embodiment of the invention, be part of a mirror system consisting of simple partially cylindrical mirrors that separately expand the image in the vertical and horizontal planes.

In an alternative embodiment of the invention, the two mirrors may be replaced by a single spherical mirror similar to a wide angle fisheye or truck mirror having image expansion properties in both planes, although this embodiment is subject to aspheric distortion which would need to be corrected for.

Alternatively, the mirror or mirrors used in the preferred embodiments of the invention may be in the form of, or include, reflective sheets arranged to expand the image in the manner disclosed in copending U.S. patent application Ser. No. ______, filed Aug. 23, 2001, and cited above.

Although the preferred embodiment includes two curved reflective surfaces on one or two mirrors with a corresponding expansion of the image in two directions, those skilled in the art will appreciate that advantages might still be obtained by using a single image-expanding mirror to expand the image in just one direction. In addition, it will be appreciated that the order or positions of the mirrors may be varied if two or more mirrors are used (e.g., vertical expansion first, then horizontal expansion), and that the image-expanding mirror or mirrors could be combined with any of numerous different combinations of focusing, collimating, shifting, and/or image expanding lenses, prisms, microprism or lenticular sheets, or other optical devices, positioned anywhere in the optical path between the projector and the screen.

### BRIEF DESCRIPTION OF THE DRAWINGS

FIG. 1 is a perspective view showing the principal components of a projection television constructed in accordance with the principles of a first preferred embodiment of the invention.

FIG. 2 is a side view of the projection television illustrated in FIG. 1.

FIG. 3A is a side view of a reflective sheet that may be used in place of the curved reflectors shown in FIGS. 1 and 2, in accordance with the principles of a second preferred embodiment of the invention.

FIG. 3B is an isometric view of the reflective sheet illustrated in FIG. 3A.

FIG. 3C is an enlarged side view of one of the individual reflector elements that make up the reflective sheet shown in FIGS. 3A and 3B.

FIG. 4 is a perspective view of a projection television system in which the two cylindrical mirrors of FIGS. 1 and 2 are replaced by a single spherical mirror.

### DETAILED DESCRIPTION OF THE PREFERRED EMBODIMENTS

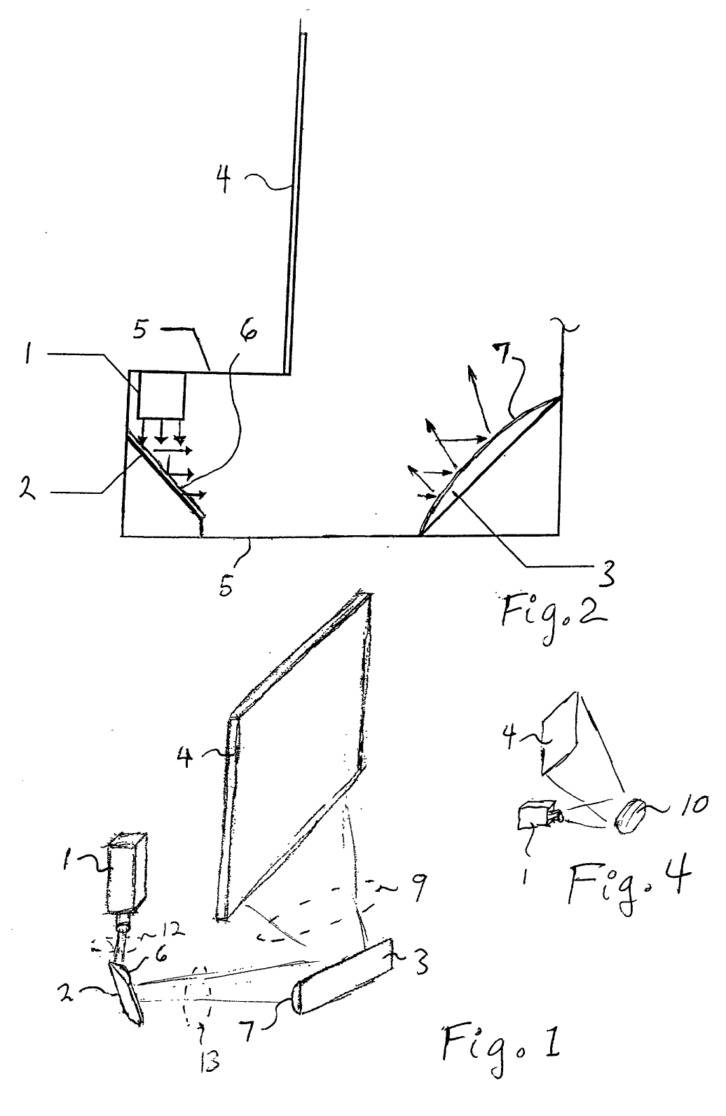

As illustrated in FIGS. 1 and 2, a projection television arranged according to the principles of a first preferred embodiment of the invention includes a projector or image source 1, a first image expanding mirror 2, a second image expanding mirror 3, and a projection screen 4. Image source 1 and projection screen 4 may be of entirely conventional size and configuration, and individually form no part of the present invention. Image source 1, mirrors 2 and 3, and projection screen 4 are housed in a cabinet 5, only portions of which are shown.

In this embodiment, mirror 2 has a generally semi-cylindrically curved surface 6 arranged to expand the image in a horizontal plane (transverse to the plane of the page illustrated in FIG. 2), but not in a vertical plane. In the vertical plane, which is parallel to the plane of the page for the view shown in FIG. 2), mirror 2 merely directs the image from the image source to the mirror 3.

Semi-cylindrical surface 6 defines a cylinder having a central axis that lies in a vertical plane including image source 1 and mirror 3, and whose orientation in that plane is determined by the relative positions of image source 1 and mirror 3, i.e., by the requirement that mirror 2 reflect the image from image source 1 to mirror 3. For a downwardly projecting image source and generally horizontally aligned mirrors 2 and 3, the central axis of the cylinder defined by surface 6 should be oriented at an angle of approximately 45° as illustrated in FIG. 2.

Mirror 3, on the other hand, is arranged to expand the image in a vertical plane (parallel to the plane of the page with respect to the view illustrated in FIG. 2), but not in the horizontal plane. The dimensions and orientation of mirror 3 are such that mirror 3 is capable of reflecting the horizontally expanded image received from mirror 2, and of projecting it onto the full width and height of the screen 4. It will be appreciated that due to the normal image expansion caused by the length of the optical path, mirror 3 does not need to extend the full width of the screen, although it could extend up to the width of the screen if the image is collimated before reaching the screen. As illustrated, the mirror 3 has a semi-cylindrical surface 7, which defines a cylinder having a central axis that extends parallel to the projection screen and lies in a horizontal plane.

In addition to mirrors 2 and 3, the rear projection television illustrated in FIGS. 1 and 2 may include lenses, prisms, microprism or lenticular sheets, and/or other optical elements for the purpose of providing additional image enlargement, and therefore of further decreasing the size of the television, or for any other purpose in which lenses are conventionally included in projection televisions, included focusing, collimating, shifting, and/or image correction or enhancement. These additional optical elements are represented in FIG. 1 by elements 9, 12, and 13, although it is to be appreciated that elements 9, 12, and 13 are schematically shown and not intended to depict the actual position or configuration of the additional lenses or prisms.

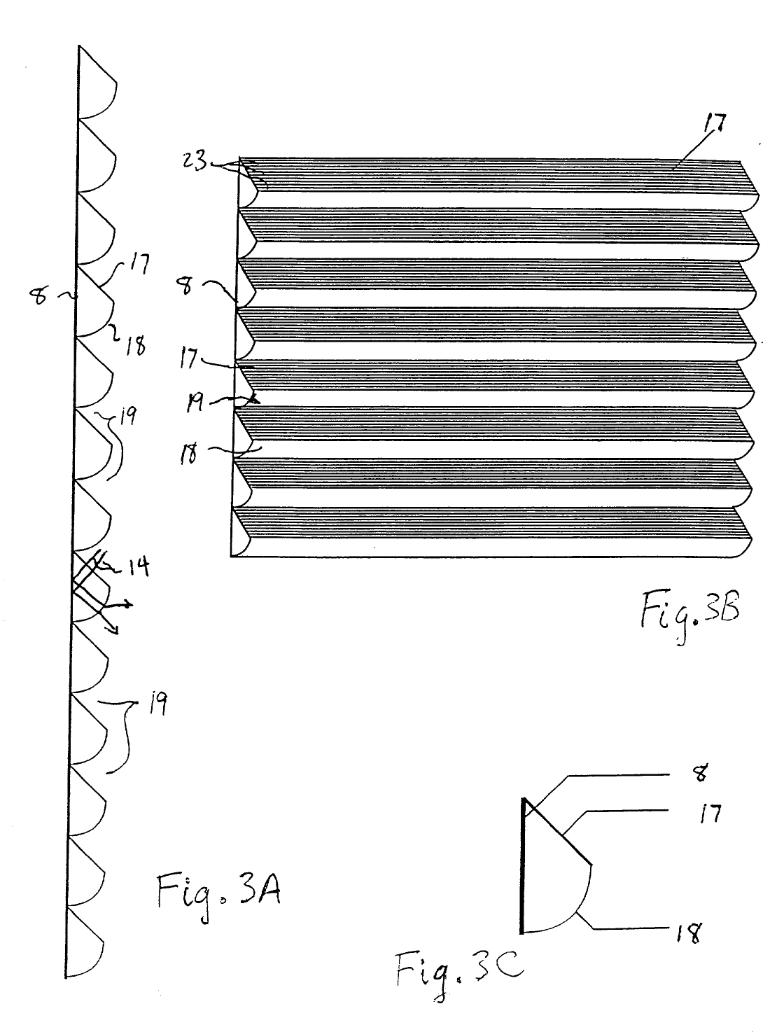

Although mirrors 2 and 3 may be simple curved mirrors, it is also possible to use reflective sheets having similar image expanding properties, as disclosed in copending U.S. patent application Ser. No. 09/934,641, filed Aug. 23, 2001, one example of which is illustrated in FIGS. 3A-3B. The reflective sheets of this embodiment of the invention include a substrate made of a transparent material such as glass or plastic formed on a first side with a plurality of “one dimensional” parallel prismatic and/or lenticular structures (referred-to for convenience as the “front” side), and with a planar surface 8 on the rear side, the planar surface serving as the reflective surface.

The reflective surface 8 of the mirror structures in this embodiment of the invention may be formed by any reflector-creating method or apparatus known, or that may become known, to those skilled in the art, including coating or deposition methods that place a reflective material such as a metal on the substrate, lamination methods, and methods of creating reflectors by polishing of the appropriate surfaces.

In the reflective sheets illustrated in FIGS. 3A-3C, the prism structures are formed by planar surfaces 17 and convex surfaces 18 that provide the image expanding effects and that intersect to form parallel grooves 19. Planar surfaces 17 may further include microlens structures 23 or, alternatively, image expansion could be obtained by appropriate curvature of the reflective surfaces, or a combination of micro-lens and reflective surface effects. It will of course be appreciated by those skilled in the art that the effect of convex or concave surfaces on the image will depend on the angle of incidence, i.e., on the orientation of the reflector relative to the immediate source of the image incident on the reflector, and also on whether light rays 14 illustrated in FIG. 3A, initially encounter the planar surface 17 or the curved surface 18, if any, of the respective reflector. For example, as illustrated, the reflector of FIG. 3A serves to enlarge a reflected image, and thus is especially suitable for use in a rear projection television system, although numerous other image enlarging reflective sheet configurations could be substituted for the reflective sheet illustrated in FIG. 3A, including several alternative configurations disclosed in the above-cited copending U.S. patent application Ser. No. 09/934,641.

In the embodiment illustrated in FIG. 4, mirrors 2 and 3 of the first preferred embodiment of the invention may be replaced by a single mirror 10 (or corresponding reflective sheet of the type disclosed in U.S. patent application Ser. No. 09/934,641) that expands the image in both directions to cover the projection screen. While this embodiment uses less parts than the first preferred embodiment, the spherical mirror is subject to aspheric distortion which must be corrected for, and thus is considered less practical at this time than the mirror system of the first preferred embodiment.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

I claim:

1. Image projection apparatus, comprising:
an image source;
a projection screen;
a mirror system arranged to reflect an image to the projection screen, wherein said mirror system includes horizontally and vertically curved surfaces arranged to expand said image in two mutually transverse planes.

2. A projection apparatus as claimed in claim 1, wherein said mirror system includes a first mirror arranged to expand said image in a horizontal direction, and a second mirror arranged to expand the horizontally-expanded image in a vertical direction.

3. A projection apparatus as claimed in claim 2, wherein said first mirror is a partially cylindrical mirror having a cylinder axis extending in a vertical plane.

4. A projection apparatus as claimed in claim 3, wherein said second mirror is a partially cylindrical mirror having a cylinder axis extending in said horizontal plane.

5. A projection apparatus as claimed in claim 2, wherein said second mirror is a partially cylindrical mirror having a cylinder axis extending in said horizontal plane.

6. A projection apparatus as claimed in claim 1, wherein said horizontally and vertically curved surfaces are surfaces of a single mirror having a partially spherical surface.

7. A projection apparatus as claimed in claim 1, wherein at least one of said horizontally and vertically curved surfaces are surfaces of a reflective sheet comprising a microprism or lenticulated sheet structure, in which one or more surfaces of the sheet are made reflective through the use of polishing or the addition of a reflective coating, and in which at least one surface of the sheet has image expansion properties.

8. A projection apparatus as claimed in claim 7, wherein said reflective sheet includes a planar reflective surface, and a convexly curved transparent surface that expands an image following reflection from said planar reflective surface.

9. Image projection apparatus, comprising:
an image source;
a projection screen;
a mirror system arranged to reflect an image to the projection screen, wherein said mirror system includes at least one curve reflective surface arranged to expand said image in at least one of a vertical and a horizontal direction.
